(19) United States
(12) Patent Application Publication
(10) Pub. No.: US 2026/0358591 A1
(43) Pub. Date: Nov. 12, 2026

(54) REAR END COVER WITH INTEGRATED LATCH FOR A FIBER OPTIC CONNECTOR

(71) Applicant: US Conec Ltd., Hickory, NC (US)

(72) Inventors: Jason Higley, Hickory, NC (US); Darrell R. Childers, Hickory, NC (US); Jeff Hendrick, Hickory, NC (US)

(21) Appl. No.: 19/651,994

(22) Filed: Apr. 20, 2026

Related U.S. Application Data
(60) Provisional application No. 63/804,188, filed on May 12, 2025.

(51) Int. Cl. G02B 6/44

(52) U.S. Cl. CPC G02B 6/4476

(57) ABSTRACT

A fiber optic connector has a crimp body that allows for a crimp band, a heat shrink tube, an abbreviated crimp band or a combination to be attached to the connector housing, and a rear end cover to cover the crimp body and associated components and remove the fiber optic connector from a telecommunications device after the latch has been freed

### REFERENCE TO RELATED CASE

This application claims priority under 35 U.S.C. § 119 (e) to U.S. provisional Application no. 63/804,188 filed on May 12, 2025, the contents of which are hereby incorporated by reference in their entirety

### BACKGROUND OF THE INVENTION

Certain fiber optic connectors (or “connectors”) have latches that aid attachment to adapters or other telecommunication structures. These connectors are different from certain other connectors that do not require latches and instead rely on latches inside the adapters to securely attach thereto (e.g., MPO connectors and adapters). Recently, smaller form factor connectors have been gaining popularity for several reasons. One such small form factor or very small form factor (VSFF) connector is the MMC® brand connector provided by the Applicant.

These VSFF connectors have an elongated boot that has a latching mechanism attached to it. This elongated boot, also referred to as a push-pull boot, has an opening in a central portion thereof to receive a crimp band, which is surrounded by the boot material once installed inside the boot during assembly of the fiber optic connector. Such installation is available in other types of fiber optic connectors with push-pull boots, including MPO connectors.

When such connectors are aggregated together inside a pulling grip with terminated fiber cables, the elongated push-pull boot adds to the space each connector takes up inside the pulling grip due to its length. This also results in an increase in an overall size and/or length of the pulling grip making it more expensive and bulkier. The pulling grip itself is a known standard piece of equipment in the optical communications industry and is not being described herein.

In certain other applications, there is no need for a boot, e.g., inside a fiber optic cassette. In such applications, significant space savings are found as compared to the pulling grip. As such, there are also applications where the space along a Z-axis or a longitudinal or mating axis is limited, and such relatively long push-pull boots with latching mechanisms would not fit in this space and are not even needed particularly. Even in those optical connectivity applications, there is still a need for connector latching to an adapter or other telecommunications structure.

### SUMMARY OF THE INVENTION

According to one aspect, the present invention is directed to a fiber optic connector that includes a connector housing configured to support at least two optical fiber, a crimp body attached to a rear end of the connector housing, and a rear end cover for the connector housing having a tubular body surrounding the crimp body and an integrated latch arm unitarily molded with the tubular body, the integrated latch arm extending forwardly and away from the tubular body, and wherein the rear end cover is fixedly engaged with the connector housing and extends rearwardly of the crimp body.

In some embodiments, there is a crimp band surrounding at least a portion of the crimp body and engaged with the crimp body.

In some embodiments, the crimp band extends rearwardly of the crimp body.

In some embodiments, the crimp band extends rearwardly to an end of the crimp body.

In some embodiments, the rear end cover extends rearwardly of the crimp body at least as far as the crimp band.

In some embodiments, there is also a heat shrink tube partially surrounding a fiber optic cable jacket containing the at least two optical fibers, the heat shrink tube at least partially surrounded by the tubular body.

In some embodiments, there is also a heat shrink tube partially surrounding a fiber optic cable jacket containing the at least two optical fibers, the heat shrink tube at least partially engaging the crimp body directly.

In some embodiments, there is also a fiber optic ferrule supported by the connector housing and configured to terminate the at least two optical fibers.

In some embodiments, the tubular body has a length that is upto 15 % longer than a length of the crimp band.

In some embodiments, the integrated latch arm has dovetail projections at a forward end to engage a groove in the connector housing.

In some embodiments, the integrated latch arm has a stiffening projection on a top portion thereof.

In some embodiments, the integrated latch arm has a stiffening projection on an underside thereof.

In some embodiments, pressing on the stiffening projection on the top of the integrated latch arm causes a movement of a latch on the integrated latch arm to release the fiber optic connector from a telecommunications structure.

In some embodiments, the engagement of connector housing with the rear end cover and the integrated latch arm with the groove prevent the connector housing from moving relative to the rear end cover.

In some embodiments, the rear end cover has a circular opening between the tubular body and the integrated latch arm.

In yet another aspect, there is a fiber optic connector includes a connector housing configured to support at least two optical fibers, a crimp body attached to a rear end of the connector housing, a crimp band surrounding at least a portion of the crimp body, and a rear end cover for the connector housing having a tubular body surrounding the crimp body and the crimp band, and an integrated latch arm unitarily molded with the tubular body, the integrated latch arm extending forwardly and away from the tubular body and connected to the connector housing, and wherein the tubular body is fixedly engaged with the connector housing and extends rearwardly of the crimp body.

In yet another aspect, there is a fiber optic connector that includes a connector housing configured to support at least two optical fibers, a crimp body attached to a rear end of the connector housing, a rear end cover for the connector housing having a tubular body surrounding the crimp body and an integrated latch arm unitarily molded with the tubular body, the integrated latch arm extending forwardly and away from the tubular body, and wherein the tubular body is fixedly engaged with the connector housing and extends rearwardly of the crimp body, and a heat shrink tube partially surrounding a fiber optic cable jacket containing the at least two optical fibers, the heat shrink tube extending into the rear end cover from the rear end.

In some embodiments, the heat shrink tube also engages a portion of the crimp body.

In some embodiments, it also includes a crimp band, the heat shrink tube being disposed between the crimp band and the crimp body.

In some embodiments, it also includes a crimp band, the heat shrink tube being disposed around at least a portion of the crimp band.

It is to be understood that both the foregoing general description and the following detailed description of the present embodiments of the invention are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, explain the principles and operations of the invention.

### BRIEF DESCRIPTION OF THE DRAWINGS

FIG. 1 is an elevational view of the right side of one embodiment of a fiber optic connector according to an embodiment of the present invention;

FIG. 2 is an elevational view of the fiber optic connector in FIG. 1 with the rear end cover in cross-section;

FIG. 3 is an exploded view of the fiber optic connector of FIG. 1 from the left side;

FIG. 4 is a cross-section view from the right side of the fiber optic connector in FIG. 1;

FIG. 5 is a perspective view of the rear end cover from the lower left side;

FIG. 6 is a left side view of the rear end cover;

FIG. 7 is a cross-section view of the rear end cover in FIG. 7;

FIG. 8 is a right-side perspective view of the fiber optic connector in FIG. 1 with the rear end cover just before or during attachment to the connector housing;

FIG. 9 is a rearward view of the connector housing showing the crimp body;

FIG. 10 is a detailed view of the connector housing just before the rear end cover is fixedly attached thereto;

FIG. 11 is a detailed view of the connector housing with the rear end cover fixedly attached to the connector housing;

FIG. 12 is a plan view of a cross section of the bottom of the fiber optic connector engaged with the rear end cover;

FIG. 12A is a detailed view of a portion of the fiber optic connector in FIG. 12;

FIG. 13 is an exploded view of another embodiment of a fiber optic connector according to the present invention from the left side;

FIG. 14 is a cross-section view from the left side of the fiber optic connector in FIG. 14; and

FIG. 15 is a cross-section view of another embodiment of a fiber optic connector according to the present invention from the left side.

### DETAILED DESCRIPTION OF THE INVENTION

Reference will now be made in detail to the present preferred embodiment(s) of the invention, examples of which are illustrated in the accompanying drawings. Whenever possible, the same reference numerals will be used throughout the drawings to refer to the same or like parts.

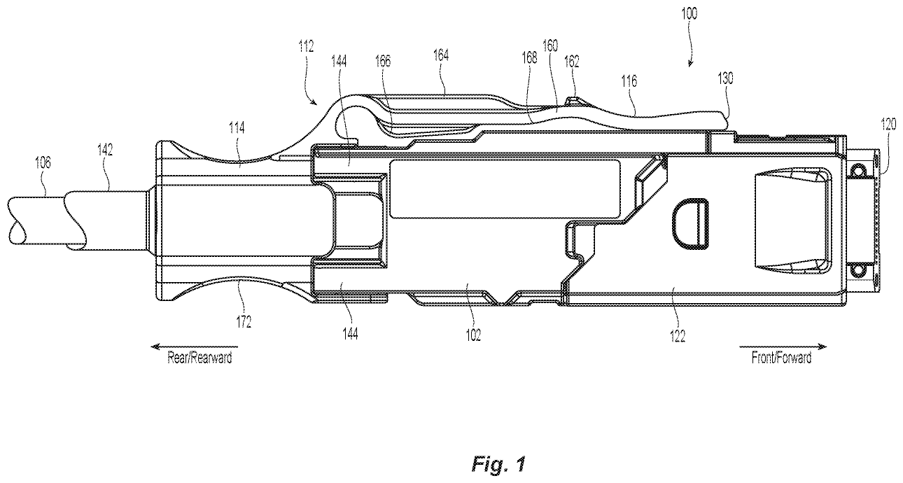

Applicant notes that the term “front” or “forward” means that direction where the fiber optic ferrule would meet with another fiber optic ferrule, device like a transceiver, adapter, or a receptacle (generally referred to as a “telecommunication structure”), while the term “rear” or “rearward” is used to mean the direction from which the optical fibers enter the fiber-optic ferrule or fiber optic connector. In the present application, the fiber optic connector 100 will therefore have a front and a rear, the front will be inserted into a telecommunications structure. Thus, in FIG. 1, the “front” of the fiber optic connector 100 is on the right side of the figure and in the plane of the page. The “rear” or “back” is that part of the fiber optic connector 100 that is on the left side of the page (from where the optical fibers come), and “rearward” and “backward” is toward the left and on the plane of the page.

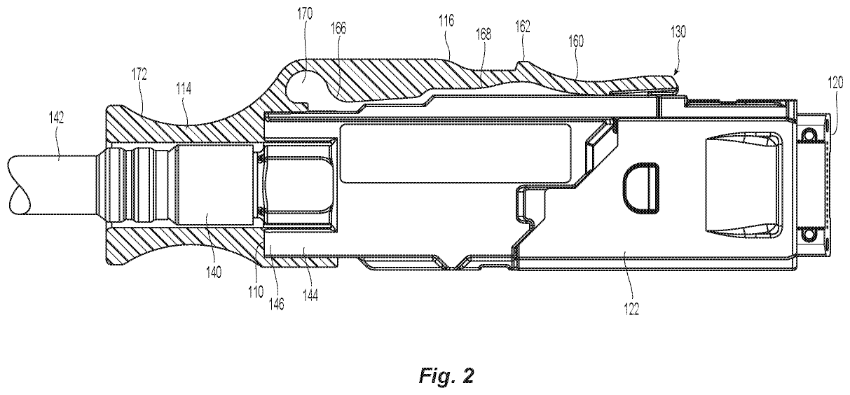

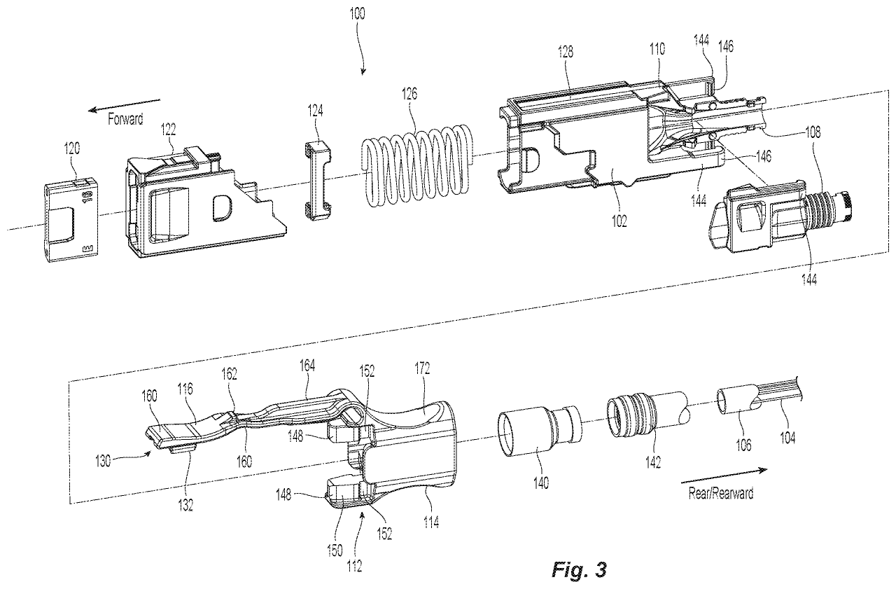

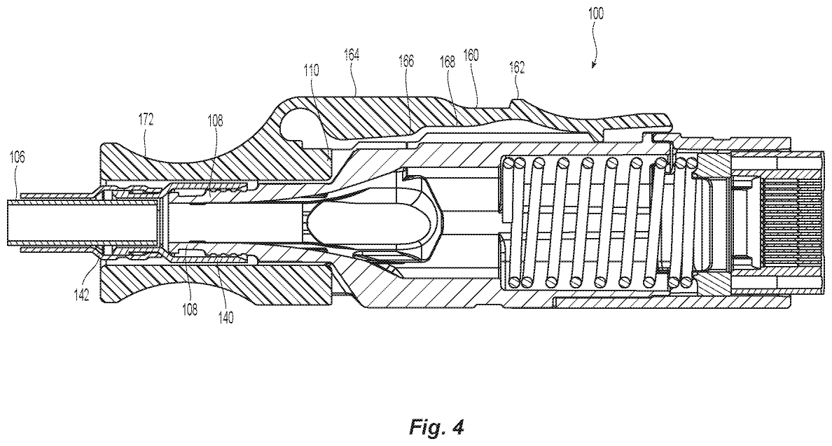

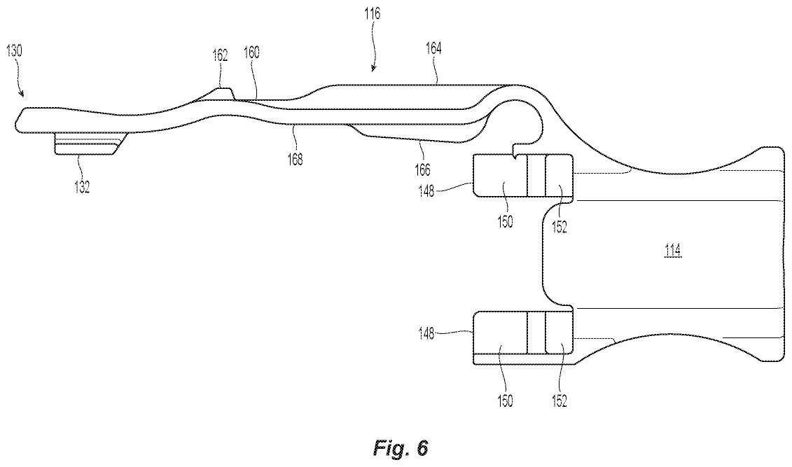

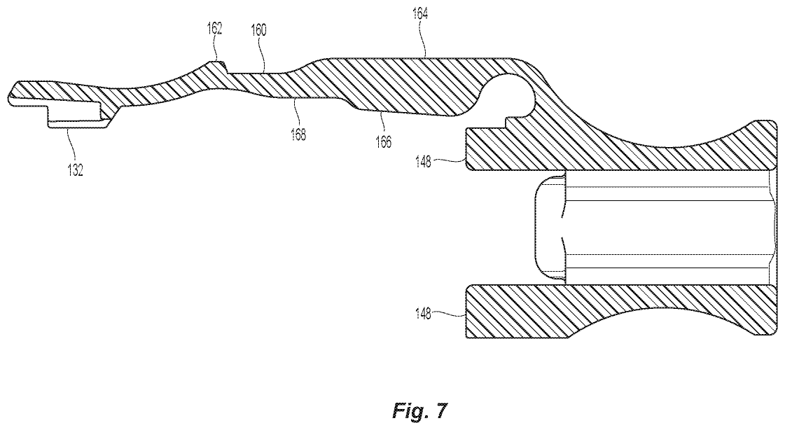

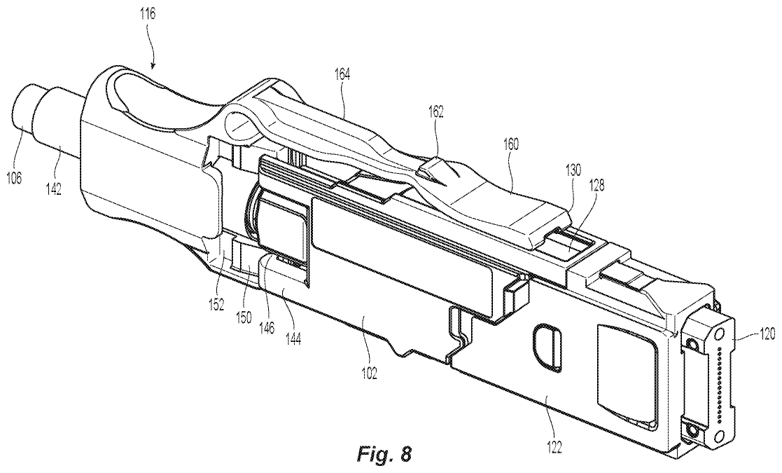

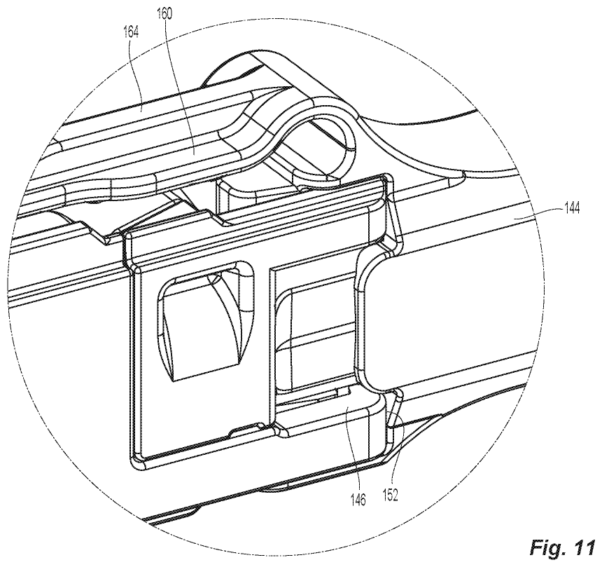

Illustrated in FIGS. 1-12A is one embodiment of a fiber optic connector 100 according to the present invention. The fiber optic connector 100 includes a connector housing 102 configured to support at least two optical fibers 104 that are in a fiber optic cable jacket 106. The fiber optic connector 100 also has a crimp body 108 at a rear end 110 of the connector housing 102. The crimp body 108 is preferably integral with the connector housing 102, although it could be a separate piece that is fixed to the connector housing 102 or even is comprised of two separate pieces, as illustrated in FIGS. 3 and 4, for example. The fiber optic connector 100 also has a rear end cover 112 for the connector housing 102. The rear end cover 112 has a tubular body 114 surrounding or covering the crimp body 108 and an integrated latch arm 116 unitarily molded with the tubular body 112. The integrated latch arm 116 extends forwardly and away from the tubular body 114, the rear end cover 112 is fixedly engaged with the connector housing 102 and extends rearwardly of the crimp body 108. Except for the rear end cover 112, a slightly different version of the fiber optic connector is discussed in detail in Applicant's U.S. Pat. No. 12,546,954, issued on Feb. 10, 2026, the contents of which are incorporated herein by reference in its entirety. In that embodiment, the crimp body is slightly different in that it has some other types of projections around the circumference of the crimp body at the rear end thereof, which also work well with various aspects of this disclosure.

Further details of the fiber optic connector 100 are illustrated in FIG. 3, where the fiber optic connector 100 is shown in an exploded view. The fiber optic connector 100 has a fiber optic ferrule 120 that is held by the ferrule holder 122 and terminates the optical fibers 104. The fiber optic ferrule 120 may be made of clear or translucent material, i.e., a lensed fiber optic ferrule with expanded beam optics, or opaque material, i.e., a physical contact fiber optic ferrule. The ferrule holder 122 is connected to the connector housing 102 in a conventional manner typical of the MMC® brand connector. The fiber optic connector 100 may also have a spacer 124 disposed between the fiber optic ferrule 120 and a spring 126 that biases the fiber optic ferrule 120 in a forward direction. Alternatively, the fiber optic connector 100 may have a pin clamp and guide pins instead of the spacer 124 when in a male connector configuration. The connector housing 102 is the central element that retains the spacer 124, the fiber optic ferrule 120, and the spring 126, while also having the crimp body 108. The fiber optic connector 100 also engages with the rear end cover 112 as discussed herein.

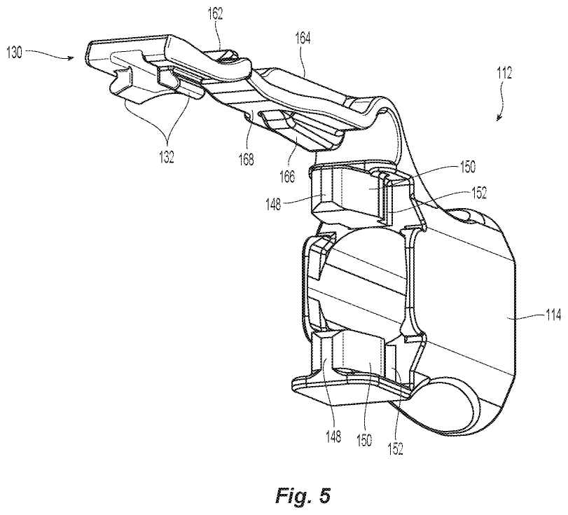

The connector housing 102 also has on one side a groove 128 to receive a forward portion 130 of the integrated latch arm 116. As best viewed, e.g., in FIGS. 5-7, there are two dove-tail projections 132 that are inserted into the groove 128. The two dove-tail projections 132 are inserted into the groove 128 from the rear when the rear end cover 112 is being attached or installed on the connector housing 102 from the rear. To install the rear end cover 112, the two dove-tail projections 132 are slid into the groove 128. The integrated latch arm 116 thus extends all the way to the front of the groove 128 of the connector housing 102 in a fully engage or fully installed configuration of the rear end cover 112. Once fully installed, as further described herein, the integrated latch arm (and, the whole of the rear end cover 112 as such), does not have any substantial sliding motion relative to the connector housing 102. Thus, in this respect, the rear cover 112 is fixedly attached to the connector housing 102.

The crimp band 140 is placed around an outside portion of the crimp body 108 to secure aramid yarn threads (not shown) from the fiber optic cable jacket 106 to the crimp body 108 and the connector housing 102 to provide strain-relief. The fiber optic cable jacket 106 abuts the rear end of the crimp body 108. See FIG. 4. Finally, a heat shrink tube 142 is then placed over a rearward extending portion of the crimp band 140 and the fiber optic cable jacket 106. See FIG. 4.

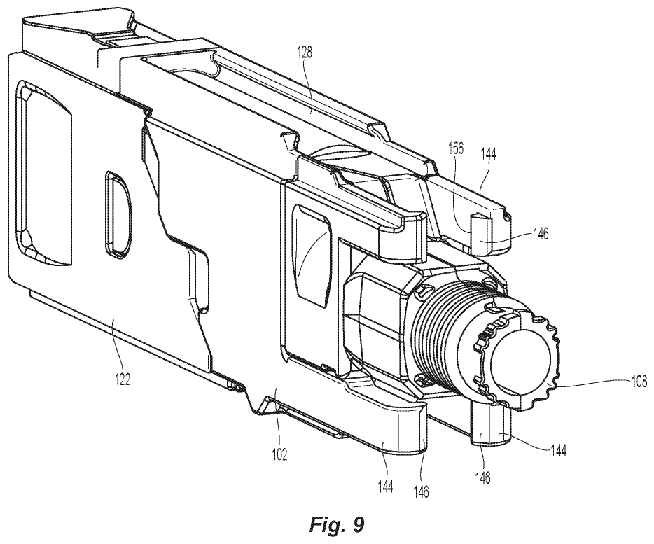

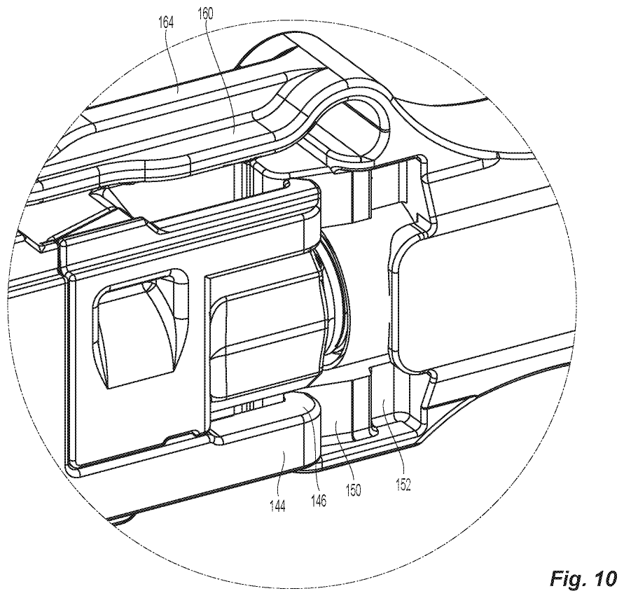

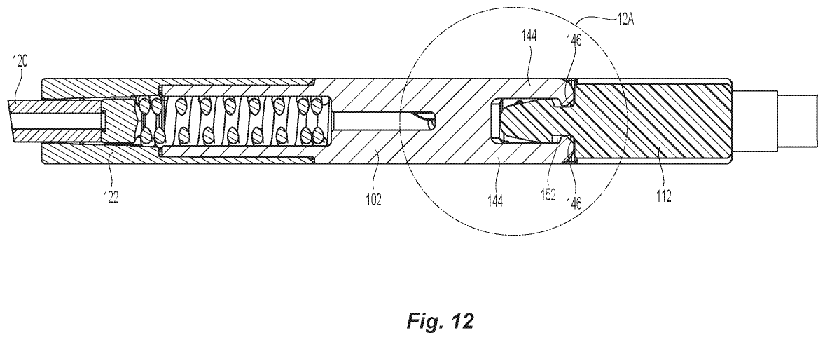

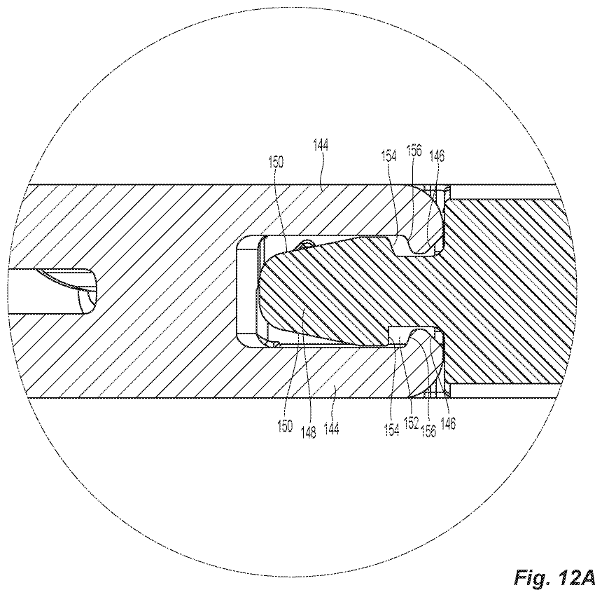

The connector housing 102 may also include four rearward extending arms 144 at the corners of the connector housing 102. The rearward extending arms 144 are positioned to engage and hold the rear end cover 112 to the connector housing 102 by way of the inward projecting portions 146. The rear end cover 112 has two forward latches 148, one towards the bottom of the fiber optic connector 100 and one towards the top. See FIGS. 5-7 and 10-12. The latches 148, by way of chamfered surfaces 150, force the rearward extending arms 144 open or flare away from each other as the rear end cover 112 is pushed towards the connector housing 102. At the rear end of the chamfered surfaces 150 is a pocket 152 with a rearward facing surface 154 for engaging the forward-facing surface 156 of the rearward extending arms 144. See, e.g., FIG. 9. As can be seen in FIGS. 10-12, and also with regard to FIG. 12A, once the inward projecting portions 146 are within the pockets 152 and the two surfaces 154,156 are engaged, the rear end cover 112 does not move relative to the connector housing 102. The two dove-tail projections 132 that are inserted into the groove 128 also cannot move relative to the connector housing 102, thereby capturing the integrated latch arm 116.

On a top surface 160 of the integrated latch arm 116 is a receptacle latch 162. The receptacle latch 162 engages with an adapter or other telecommunications apparatus to retain the fiber optic connector 100 in the adapter to engage another fiber optic connector 100 or other device. Also on the top surface 160 is a stiffening projection 164 that is pressed on by a user to release the receptacle latch 162 from the adapter or other telecommunications apparatus. See again, e.g., FIG. 5. There may also be a second stiffening projection 166 that is on an underside 168 of the integrated latch arm 116 to provide more rigidity to the rear end cover 112.

Between the integrated latch arm 116 and the tubular body 114 of the rear end cover 112 is a rounded opening 170, which is another area in which a user can press to release the fiber optic connector 100. Finally, the tubular body 114 has a grasping area 172 for the user, after pressing on the stiffening projection to release the receptacle latch 162, to use to pull the fiber optic connector 100 from the adapter or the receptacle. However, only pulling on the tubular body 114 and the grasping area 172 will not cause the fiber optic connector 100 to be released from an adapter, etc. because the rear end cover 112 is fixedly attached to the connector housing 102 as described above. Due to this fixed attachment, simply pulling the rear end cover 112 will not affect the configuration of the receptacle latch 162 that engages the telecommunications structure. In this respect, the rear end cover 112 operates differently from a traditional push-pull boot in that the traditional push pull boot has to slide or translate relative to the rest of the fiber optic connector to actuate the latch securing the fiber optic connector to the telecommunications structure. Instead, the integrated latch arm 116 must be first pushed towards the connector housing 102, e.g., by pressing on stiffening projection 164 to have the receptacle latch 162 fall out of a latch window (not shown) of the telecommunications structure, and then the fiber optic connector 100 may be pulled out. This mechanism of removal of the fiber optic connector 100 thereby gets rid of the need for any significant translation of the rear end cover 112 relative to the connector housing 102, which is advantageous in tight longitudinal spaces, such as cassettes, for example.

Returning to FIG. 4, there are several observations to be made about the crimp body 108, the crimp band 140, the heat shrink tube 142 and the rear end cover 112. The crimp band 140 surrounds at least a portion of the crimp body 108 and is engaged with the crimp body 108. The crimp band 140 extends rearwardly of the crimp body 108. The tubular body 114 of the rear end cover 112 extends rearwardly of the crimp body 108 at least as far as the crimp band 140. In FIG. 4, the rear end cover 112 extends slightly farther rearwardly than the crimp band 140. By way of example only and not by way of limitation, the tubular body 114 has a length that is up to 15% longer than a length of the crimp band 140.

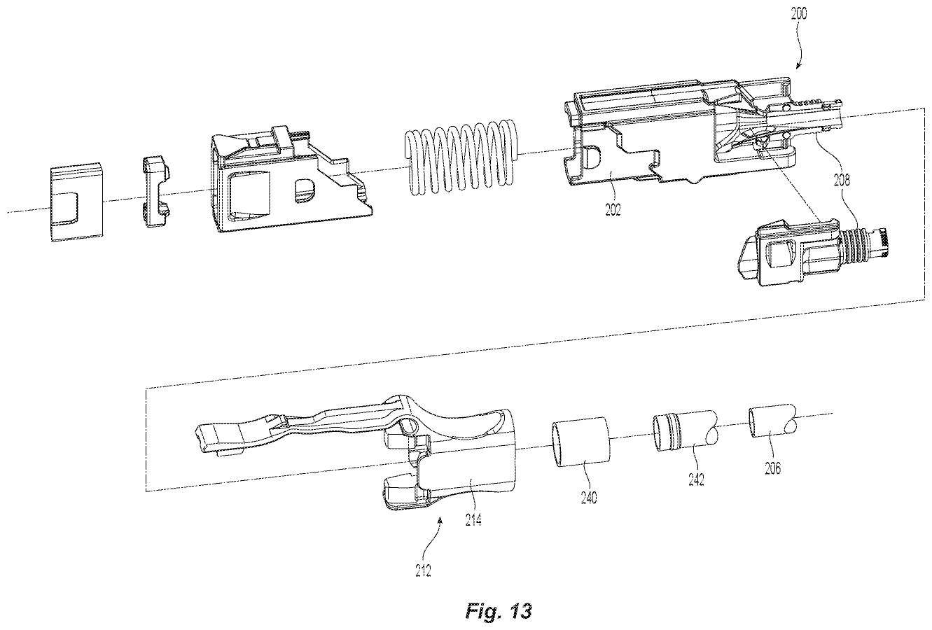

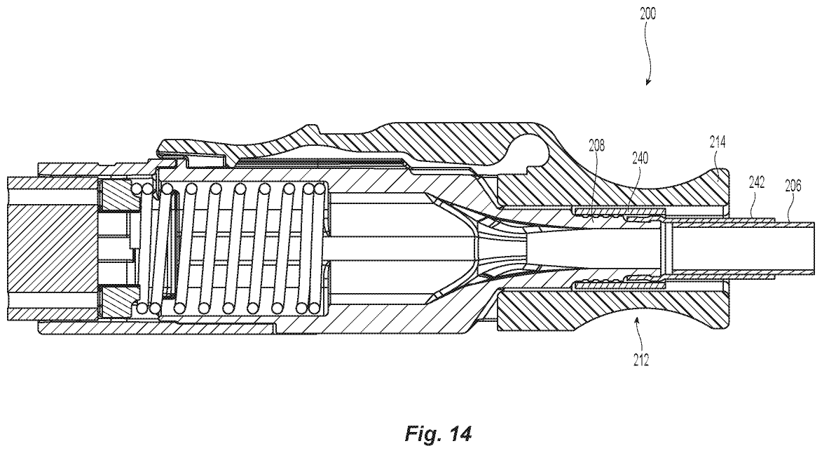

Another embodiment of a fiber optic connector 200 is illustrated in FIGS. 13 and 14. A quick comparison of the fiber optic connector 200 in FIG. 13 with the fiber optic connector 100 in FIG. 3 shows that the only difference between the two fiber optic connectors is that the length of the crimp band 240 is different and is shorter. FIG. 14 shows that the crimp band 240 is the same length of the crimp body 208 and both end at the same spot within the tubular body 214. Again, in this respect, by way of example only and not by way of limitation, the tubular body 214 has a length that is up to 15% longer than a length of the crimp band 240. That is, the tubular body 214 is substantially the same length as the crimp body 240, unlike traditional push-pull boots that extend much farther rearward from the crimp body 208 as those push-pull boots also have to strain relieve the optical fiber cable. Additionally, the heat shrink tube 242 is at least partially between the crimp band 240 and the crimp body 208, but also extends beyond the rear end cover 212 in a rearward direction and covers the fiber optic cable jacket 106 beyond the rear end cover 212. In this embodiment, the heat shrink tube 142 is at least partially engaging the crimp body 208 directly (without a crimp band in between).

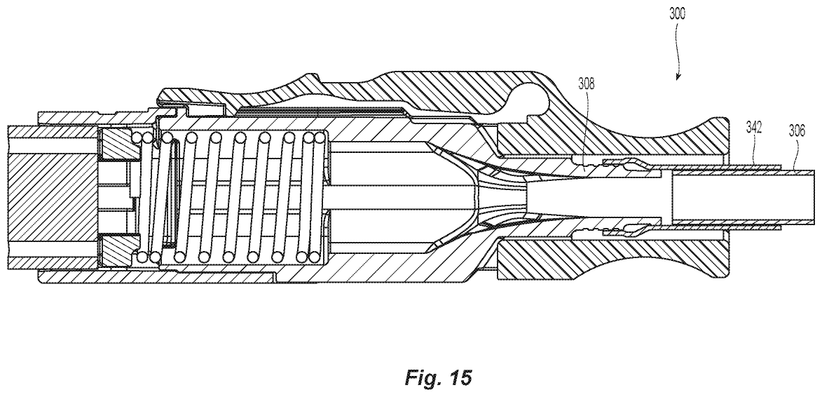

Another embodiment of a fiber optic connector 300 according to the present invention is illustrated in FIG. 15. In this embodiment, the fiber optic connector 300 does not have a crimp band. There is a crimp body 308 as with the other embodiments. A heat shrink tube 342 surrounds and is attached to a portion of the crimp body 308. The heat shrink tube 342 also covers the fiber optic cable jacket 306, and both are extending into the rear end cover from the rear end.

Various components described herein for the various embodiments may be sold as one or more bags of parts or a kit and then shipped. Those components may then be installed in cable assembly houses to form the finished fiber optic connector 100. It will be apparent to those skilled in the art that various modifications and variations can be made to the present invention without departing from the spirit and scope of the invention. Further, various features of the different embodiments may be combined or mixed without departing from the scope of this invention. Thus, it is intended that the present invention cover the modifications and variations of this invention provided they come within the scope of the appended claims and their equivalents.

We claim:

1. A fiber optic connector comprising:
a connector housing configured to support at least two optical fibers;
a crimp body attached to a rear end of the connector housing; and
a rear end cover for the connector housing having a tubular body surrounding the crimp body and an integrated latch arm unitarily molded with the tubular body, the integrated latch arm extending forwardly and away from the tubular body, and wherein the rear end cover is fixedly engaged with the connector housing and extends rearwardly of the crimp body.

2. The fiber optic connector according to claim 1, further comprising a crimp band surrounding at least a portion of the crimp body and engaged with the crimp body.

3. The fiber optic connector according to claim 2, the crimp band extends rearwardly of the crimp body.

4. The fiber optic connector according to claim 2, the crimp band extends rearwardly to an end of the crimp body.

5. The fiber optic connector according to claim 3, where the rear end cover extends rearwardly of the crimp body at least as far as the crimp band.

6. The fiber optic connector according to claim 1, further comprising a heat shrink tube partially surrounding a fiber optic cable jacket containing the at least two optical fibers, the heat shrink tube at least partially surrounded by the tubular body.

7. The fiber optic connector according to claim 1, further comprising a heat shrink tube partially surrounding a fiber optic cable jacket containing the at least two optical fibers, the heat shrink tube at least partially engaging the crimp body directly.

8. The fiber optic connector according to claim 1, further comprising a fiber optic ferrule supported by the connector housing and configured to terminate the at least two optical fibers.

9. The fiber optic connector according to claim 2, wherein the tubular body has a length that is upto 15% longer than a length of the crimp band.

10. The fiber optic connector according to claim 1, wherein the integrated latch arm has dovetail projections at a forward end to engage a groove in the connector housing.

11. The fiber optic connector according to claim 1, wherein the integrated latch arm has a stiffening projection on a top portion thereof.

12. The fiber optic connector according to claim 1, wherein the integrated latch arm has a stiffening projection on an underside thereof.

13. The fiber optic connector according to claim 11, wherein pressing on the stiffening projection on the top of the integrated latch arm causes a movement of a latch on the integrated latch arm to release the fiber optic connector from a telecommunications structure.

14. The fiber optic connector according to claim 11, wherein the engagement of connector housing with the rear end cover and the integrated latch arm with the groove prevent the connector housing from moving relative to the rear end cover.

15. The fiber optic connector according to claim 1, wherein the rear end cover has a circular opening between the tubular body and the integrated latch arm.

16. A fiber optic connector comprising:
a connector housing configured to support at least two optical fibers;
a crimp body attached to a rear end of the connector housing;
a crimp band surrounding at least a portion of the crimp body; and
a rear end cover for the connector housing having a tubular body surrounding the crimp body and the crimp band, and an integrated latch arm unitarily molded with the tubular body, the integrated latch arm extending forwardly and away from the tubular body and connected to the connector housing, and wherein the tubular body is fixedly engaged with the connector housing and extends rearwardly of the crimp body.

17. A fiber optic connector comprising:
a connector housing configured to support at least two optical fibers;
a crimp body attached to a rear end of the connector housing;
a rear end cover for the connector housing having a tubular body surrounding the crimp body and an integrated latch arm unitarily molded with the tubular body, the integrated latch arm extending forwardly and away from the tubular body, and wherein the tubular body is fixedly engaged with the connector housing and extends rearwardly of the crimp body; and
a heat shrink tube partially surrounding a fiber optic cable jacket containing the at least two optical fibers, the heat shrink tube extending into the rear end cover from the rear end.

18. The fiber optic connector according to claim 17, wherein the heat shrink tube also engages a portion of the crimp body.

19. The fiber optic connector according to claim 17, further comprising a crimp band, the heat shrink tube being disposed between the crimp band and the crimp body.

20. The fiber optic connector according to claim 18, further comprising a crimp band, the heat shrink tube being disposed around at least a portion of the crimp band.
